(19) United States
(12) Patent Application Publication
(10) Pub. No.: US 2004/0160973 A1
(43) Pub. Date: Aug. 19, 2004

(54) Zero configuration auto-discovery for networks storage

(76) Inventor: Marc Timothy Jones, Longmont, CO (US)

Correspondence Address: MORRISON & FOERSTER, LLP, 555 WEST FIFTH STREET, SUITE 3500, LOS ANGELES, CA, 90013-1024, US

(21) Appl. No.: 10/365,963

(22) Filed: Feb. 12, 2003

(51) Int. Cl. H04L 12/28

(52) U.S. Cl. 370/419

(57) ABSTRACT

An adapter for a client of a storage network may perform a port scan on the network to identify storage targets, e.g., (Internet SCSI (Small Computer System Interface)) targets. The adapter may then send a resource discovery command to the identified storage targets to identify available storage resource(s) at the storage targets.

### BACKGROUND

Storage area networks (SANs) are dedicated networks for connecting servers to storage devices and transporting storage traffic. This may free resources in the enterprise network, e.g., a local area network (LAN) or wide area network (WAN). As more storage devices are added to a SAN, they too may be made accessible from any server in the enterprise network.

SANs may provide centralized data management for a LAN or WAN. This may help prevent servers that host high-demand applications and often-used data from becoming overloaded while others remain relatively idle. SANs may also be highly scalable, enabling administrators to meet growing storage demands simply by installing more storage resources.

### SUMMARY

A network may include a number of hosts and a client with an adapter. The adapter may scan the network for open ports associated with storage targets. In an embodiment, the adapter may scan the network for open iSCSI (Internet SCSI (Small Computer System Interface)) ports. The storage targets may have one or more storage resources, e.g., available disks or tapes. The adapter may send a resource discovery command, e.g., an ISCSI “SendTargets” command, to the identified storage targets, which may then send back a list identifying their available storage resources.

The adapter may be pre-configured with a discovery radius. After port scanning and identifying resources in a local network, the adapter may then perform the discovery operations on remote networks in the discovery radius. The adapter may identify router(s) or gateway(s) between the local network, to which the client may be connected, and a remote network in the discovery radius and then traverse the identified router(s)/gateway(s) to the remote network.

### BRIEF DESCRIPTION OF THE DRAWINGS

FIG. 1 is a block diagram of a storage area network (SAN).

FIG. 2 is a block diagram of an iSCSI (Internet SCSI (Small Computer System Interface)) packet.

FIG. 3 is a flowchart describing a zero configuration auto-discovery operation.

FIG. 4 is a block diagram of a network having a discovery radius outside the local subnet.

FIG. 5 is a flowchart describing a zero configuration auto-discovery operation extended across different subnets.

### DETAILED DESCRIPTION

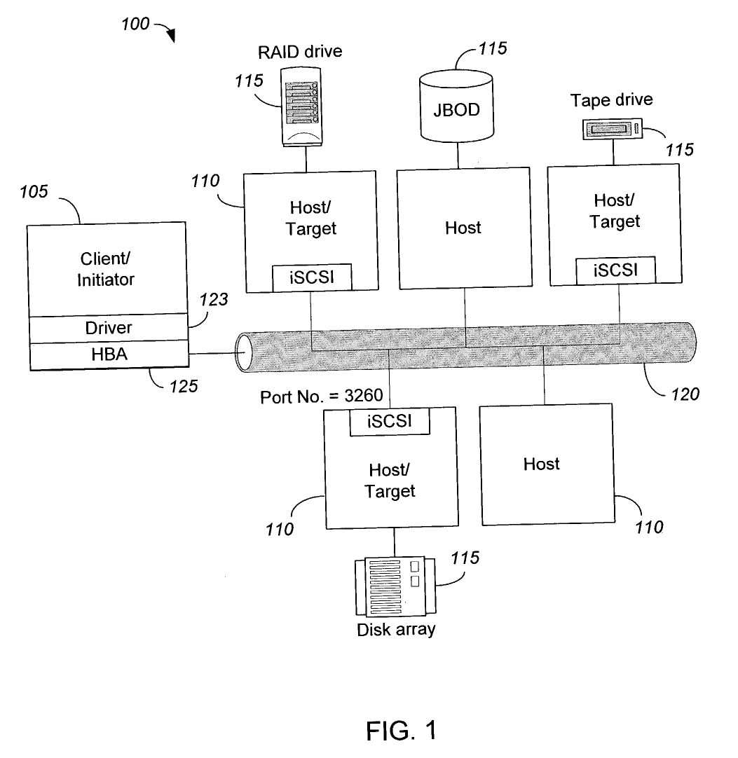

FIG. 1 shows a storage area network (SAN) 100 including a client 105 and a number of hosts 110. The client may be, for example, a file server for clients in a local area network (LAN) or one of such clients, e.g., a personal computer (PC). The hosts 110 may include storage devices 115, such as disk arrays, RAID (Redundant Array of Independent (or Inexpensive) Disks) devices, and tape libraries. Devices in the SAN 100 may communicate over a communication link 120, e.g., an Ethernet link using the TCP (Transmission Control Protocol)/IP (Internet Protocol) protocol.

The client 105 may include a storage driver 123 with a Host Bus Adapter (HBA) 125, which enables the client to connect to storage devices in the network. The storage driver 123 may handle storage requests from the client 105 and communicate such requests to the HBA 125.

The HBA 125 and one or more of the hosts 110 in the network may support the iSCSI (Internet SCSI (Small Computer System Interface)) protocol. ISCSI is a TCP/IP-based protocol for establishing and managing connections between IP-based storage devices, hosts, and clients. ISCSI builds on widely used storage and networking protocols. On the storage side, iSCSI uses the SCSI storage commands, which are commonly used for storage configurations. On the networking side, iSCSI uses IP and Ethernet protocols.

iSCSI enables block-level storage data to be carried over TCP/IP networks. ISCSI encapsulates SCSI packets in TCP for reliable transport and routing using IP. As a result, standard SCSI commands can pass between the client (as the “initiator”) and storage devices that support iSCSI (“targets”) over a standard Ethernet/IP, TCP/IP network infrastructure.

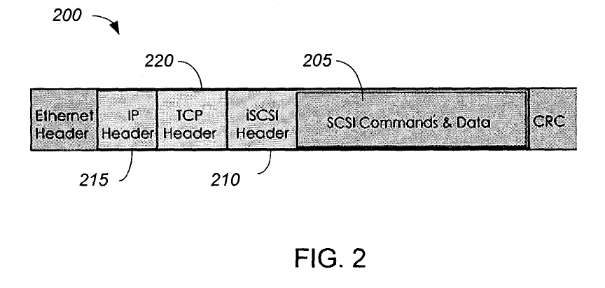

An “ISCSI packet,” such as the packet 200 shown in FIG. 2, contains SCSI commands and data 205 and an ISCSI header 210, which is created by the iSCSI initiator. The iSCSI header may be used by an iSCSI target to extract and store the I/O block data. The iSCSI header provides storage-related information, while the other headers provide information necessary for carrying out normal networking functions. For example, an IP header 215 provides packet routing information used for moving the messages across the network, and a TCP header 220 contains the identification and control data needed to guarantee message delivery to a desired destination.

The initiator 105 may want to determine which storage resources, e.g., disks, are available to it at a target. iSCSI supports a “SendTargets” command for discovery of such resources. The initiator can connect to an iSCSI address (e.g., IP address+TCP port number) and log in to the canonical target name “iscsi”. Upon successful login to the iSCSI target, the initiator may send the SendTargets command. The target must support this command, i.e., be iSCSI compliant, and must return a list of zero or more iSCSI target Names. Each iSCSI target Name returned may include zero or more TargetAddress fields, as well as an optional TargetAlias filed. The TargetAddress fields contain the IP addresses of the available storage resources, e.g., available disks. Below is an example of a list which may be returned by an iSCSI target in response to a SendTargets command:

TargetName=fqe.com.acme.diskarray.sn.8675309

TargetAddress=10.1.0.45:3000

TargetAddress=10.1.1.45:3000

TargetAlias=Oracle disk four

The IP addresses of a target must be known before a SendTargets discovery of that target can be initiated. The SAN 100 may be preconfigured such that the IP addresses of the targets are defined at the client. However, defining this information at all clients for all targets may be work-intensive and may not allow for the flexible addition of new storage devices in the SAN 100.

In an embodiment, the SAN 100 supports “zero configuration” auto-discovery of iSCSI targets. In zero configuration auto-discovery, the client 105 can determine the IP addresses of iSCSI targets in the SAN 100 and obtain a list of storage resources at those targets without the targets being pre-defined at the client.

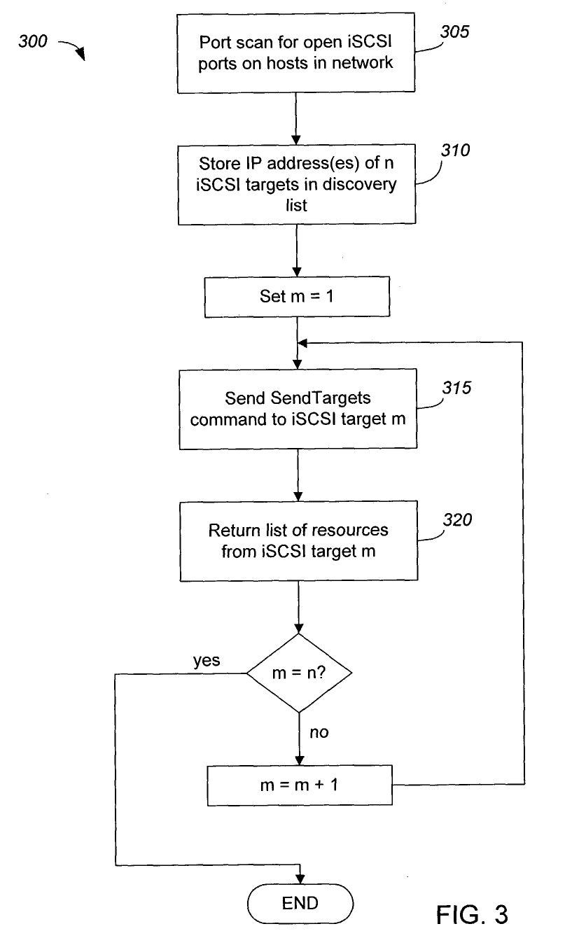

FIG. 3 is a flowchart describing a zero configuration auto-discovery operation 300. The HBA 125 may perform a port scan of the ports available on hosts in the network (block 305). Ports on hosts in the network have port numbers, which identify processes or services running on the device. For the TCP and the User Datagram Protocol (UDP) transport layer protocols, a port number is a 16-bit integer that is put in the header appended to a message unit (e.g., a packet). This port number is passed logically between client and server transport layers and physically between the transport layer and the IP layer and then forwarded on.

Some services or processes have conventionally assigned permanent port numbers. These are known as well-known port numbers. For example, SMPT (Simple Mail Transfer Protocol) is assigned port number “25” and World Wide Web-Hyper Text Transfer Protocol (WWW-HTTP) is assigned port number “80”. ISCSI has been assigned port number “3260”, and may also be associated with port number “5300”.

A port scan may be performed by sending one or more messages (e.g., packets) associated with port number(s) of interest (e.g., “3260” and “5300” for iSCSI) to a target host on the network. The HBA 125 may send a TCP Syn (Synchronize) packet sent to identify whether a socket is listening on the port of interest. If there is a socket listening on that port, then a response Syn packet will arrive from the host, otherwise an error packet will be returned (ICMP error). In this manner, the HBA 125 can determine which ports are available by the response of the host. Whenever a port scan results in an open port (e.g., a connection is established), the IP address for that host is stored in a discovery list (block 310).

The HBA 125 may then log into an ISCSI target on the discovery list using a “discovery session” (a simplified session that exists solely for discovery). Once logged in, the HBA may send a SendTargets command to the iSCSI target (block 315). The iSCSI target will then return lists of available resources, e.g., available disks (block 320). This may be repeated for all iSCSI targets on the discovery list. The complete list of targets may be stored on the HBA 125 and/or the client 105.

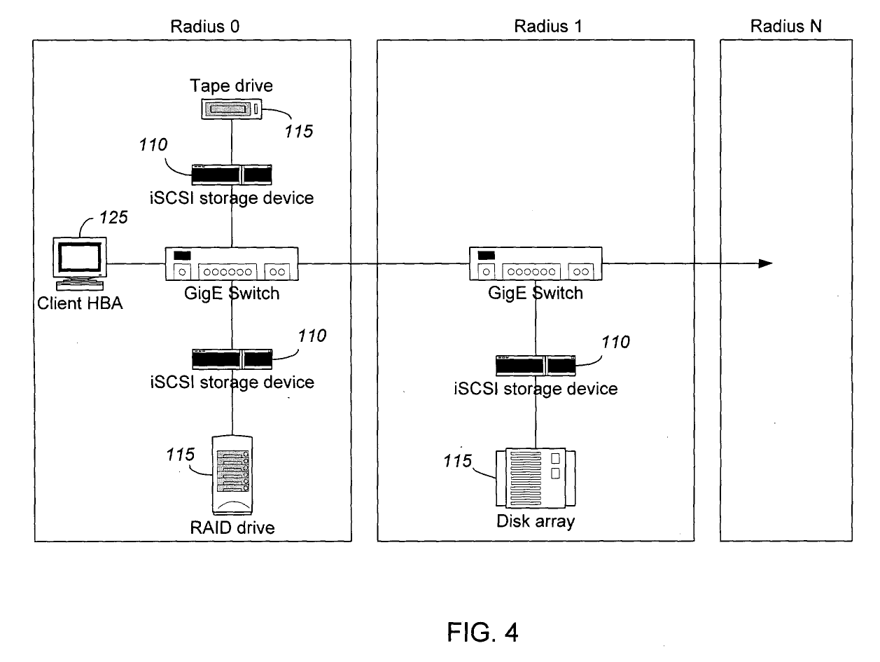

In an embodiment, the HBA 125 may be preconfigured with two items, local IP information (e.g., IP address, net mask, and gateway) and a discovery radius. The discovery radius indicates the extent to which discovery is to be performed, as shown in FIG. 4. The value of the radius represents the number of routers or gateways through which discovery will be performed. For example, a value of “0” may indicate that discovery will not be performed beyond the gateway or local subnet, a value of “1” may limit discovery to one network beyond the current gateway/router, etc.

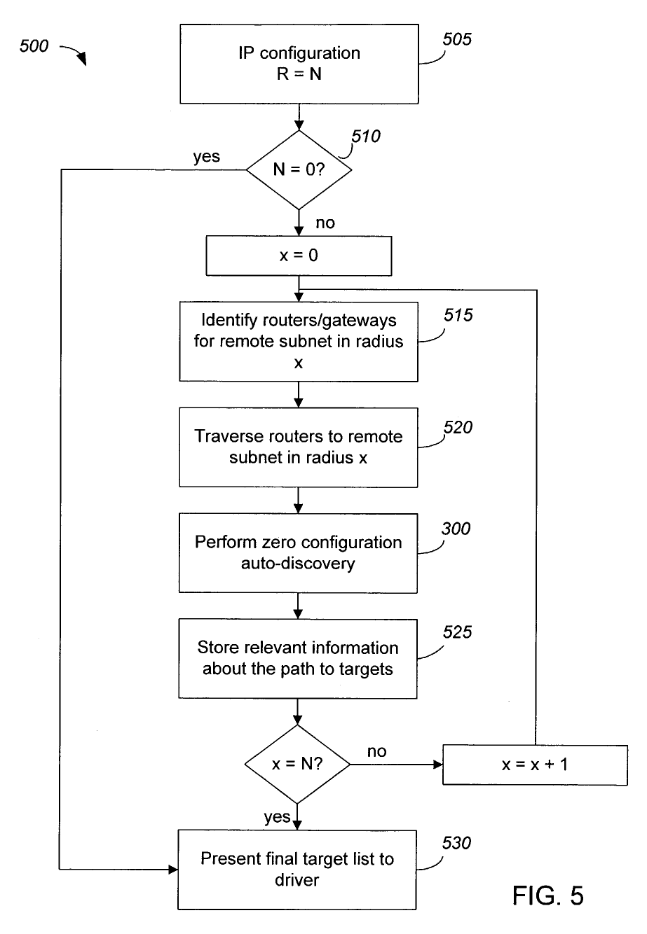

FIG. 5 is a flowchart describing a zero configuration auto-discovery operation extended across different subnets. After IP configuration (block 505), the zero configuration auto-discovery operation 300 may be performed on host targets in the local subnet (Radius 0). The local subnet (including the local gateway) is port scanned for target addresses.

If the radius is greater than 0 (block 510), a router-discovery protocol may be used to identify the routers/gateways on the remote subnet (block 515). RIP (Routing Information Protocol)and RDISC (Router Discovery Protocol) are exemplary router-discovery protocols which may be used for this purpose. The HBA 125 traverses the list of routers that lead to a unique subnet (block 520) and performs the zero configuration auto-discovery operation (300) on that network. Upon finding new targets in that network, the HBA 125 may store the address of the target, as well as relevant information about the path to the target (e.g., path MTU (Maximum Transfer Unit), RTT (Round-Trip Time), etc.) (block 525).

For radii greater 1, the process may be repeated for subsequent networks, extending the discovery through the next hop.

The final target list may then presented to the driver 123 (block 530). The final target list may include a list of targets along with relevant information about their accessibility.

With a large radius, the list may contain duplicate targets representing multiple paths to the same target device. Given path information collected, the driver can make a better choice regarding how to access the given device through explicit routing.

A number of embodiments have been described. Nevertheless, it will be understood that various modifications may be made without departing from the spirit and scope of the invention. For example, blocks in the flowcharts may be skipped or performed out of order and still produce desirable results. Accordingly, other embodiments are within the scope of the following claims.

1. A method comprising:
scanning a network for open ports associated with storage targets;
identifying one or more storage targets having one of said open ports; and
sending a resource discovery command to said one or more identified storage targets.

2. The method of claim 1, wherein said scanning comprises scanning for open iSCSI (Internet SCSI (Small Computer System Interface)) ports.

3. The method of claim 2, wherein said sending the resource discovery command comprises sending a SendTargets command.

4. The method of claim 1, further comprising receiving a list identifying one or more storage resources from each of said one or more identified storage targets.

5. The method of claim 4, wherein said list includes addresses for available storage resources.

6. The method of claim 4, wherein said one or more storage resources include at least one disk in a disk drive.

7. The method of claim 1, wherein the network comprises a local network, and
further comprising defining a discovery radius including one or more remote networks.

8. The method of claim 7, further comprising:
identifying one or more routers between the local network and a remote network in said one or more remote networks;
traversing said one or more routers to said remote network;
scanning said remote network for open ports associated with storage targets;
identifying one or more storage targets having one of said open ports in said remote network;
sending a resource discovery command to said one or more identified storage targets; and
receiving a list identifying one or more storage resources from each of said one or more identified storage targets in the remote network.

9. An apparatus comprising:
a scanning module operative to scan hosts in a network for open ports associated with storage targets and identify one or more storage targets; and
a discovery module operative to send a resource discovery command to said one or more identified storage targets.

10. The apparatus of claim 9, wherein the scanning module is operative to scan hosts in the network for targets with open iSCSI ports.

11. The apparatus of claim 10, wherein the discovery module is operative to send a SendTargets command to said one or more identified storage targets.

12. The apparatus of claim 11, wherein the network comprises a local network, and
further comprising a adapter including the scanning module and the discovery module, the adapter being configured with a discovery radius including one or more remote networks.

13. The apparatus of claim 12, wherein the adapter is operative to
identify one or more routers between the local network and a remote network in said one or more remote networks,
traverse said one or more routers to said remote network,
scan hosts in said remote network for open ports associated with storage targets;
identify one or more storage targets in said remote network; and
send a resource discovery command to said one or more identified storage targets.

14. A system comprising:
a local network including
a plurality of hosts, one or more of said hosts including an open ISCSI port and one or more storage resources, and
a client including an adapter operative to
scan the local network for open iSCSI ports,
identify hosts having iSCSI ports, and
send a SendTargets command to each of said identified hosts.

15. The system of claim 14, wherein the adapter is configured with a discovery radius including one or more remote networks.

16. The apparatus of claim 15, wherein the adapter is operative to
identify one or more routers between the local network and a remote network in said one or more remote networks,
traverse said one or more routers to said remote network,
scan hosts in said remote network for open iSCSI ports;
identify hosts having open ISCSI ports; and
send a SendTargets command to said one or more identified hosts.

17. An article comprising a machine-readable medium including machine-executable instructions operative to cause a machine to:
scan a network for open ports associated with storage targets;
identify one or more storage targets having one of said open ports; and
send a resource discovery command to said one or more identified storage targets.

18. The article of claim 17, wherein the instructions operative to cause the machine to scan comprise instruction operative to cause the machine to scan for open iSCSI (Internet Small Computer System Interface) ports.

19. The article of claim 18, wherein the instructions operative to cause the machine to send the resource discovery command comprise instructions operative to cause the machine to send a SendTargets command.

20. The article of claim 17, further comprising instructions operative to cause the machine to receive a list identifying one or more storage resources from each of said one or more identified storage targets.

21. The article of claim 20, wherein said list includes addresses for available storage resources.

22. The article of claim 20, wherein said one or more storage resources include at least one disk in a disk drive.

23. The article of claim 17, wherein the network comprises a local network.

24. The article of claim 23, further comprising instructions operative to cause the machine to:
identify one or more routers between the local network and a remote network in a discovery radius;
traverse said one or more routers to said remote network;
scan said remote network for open ports associated with storage targets;
identify one or more storage targets having one of said open ports in said remote network;
send a resource discovery command to said one or more identified storage targets; and
receive a list identifying one or more storage resources from each of said one or more identified storage targets in the remote network.
